(19) United States
(12) Patent Application Publication
(10) Pub. No.: US 2020/0257677 A1
(43) Pub. Date: Aug. 13, 2020

(54) METHOD AND DEVICE FOR UPLOADING USER INFORMATION, AND COMPUTER-READABLE STORAGE MEDIUM

(71) Applicant: Ping An Technology (Shenzhen) Co., Ltd., Shenzhen City, Guangdong (CN)

(72) Inventors: Ruiyang Wang, Shenzhen, Guangdong (CN); Bin Li, Shenzhen, Guangdong (CN)

(73) Assignee: Ping An Technology (Shenzhen) Co., Ltd., Shenzhen, Guangdong (CN)

(21) Appl. No.: 16/320,108

(22) PCT Filed: Sep. 26, 2017
(86) PCT No.: PCT/CN2017/103547

§ 371 Date: Jan. 24, 2019

(30) Foreign Application Priority Data
Aug. 24, 2017 (CN) 201710741116.4

(51) Int. Cl. G06F 16/23; H04L 29/08; G06F 11/07

(52) U.S. Cl. CPC G06F 16/2386; G06F 11/0766; H04L 67/2852; H04L 67/1085

(57) ABSTRACT

Disclosed are a method and a device for uploading user information, as well as a computer-readable storage medium. The method for uploading user information includes: in response to detection of a user information uploading request, obtaining the user information to be uploaded; storing the user information to be uploaded in an intermediate interface table of an uploading system; selecting the user information to be uploaded from the intermediate interface table at intervals of a predetermined time period, and uploading the user information to be uploaded that is selected to a target user information pool in batches.

The present application claims priority to China Patent Application No. 201710741116.4, filed Aug. 24, 2017 with the State Intellectual Property Office and entitled “Method and Device for Uploading User Information, and Computer-readable Storage Medium”, the entirety of which is hereby incorporated herein by reference.

### TECHNICAL FIELD

The present disclosure relates to the field of data uploading, and more particularly relates to a method and a device for uploading user information, as well as a computer-readable storage medium.

### BACKGROUND

Often times, various types of user information such as a user's phone number, native place, mailbox, and age need to be uploaded to a corresponding user pool by means of an Excel table, a Word file or the like. During the process of uploading various types of user data to the corresponding user pool, if the capacity of the user information is too large and the user information items are exceedingly numerous, then the user information would need to be manually inputted to the corresponding user pool in batches in order to avoid collapse of the uploading system. This process, however, can be time-consuming and manpower-consuming, and result in poor experience.

### SUMMARY

It is therefore one main object of the present disclosure to provide a method and a device for uploading user information as well as a computer-readable storage medium, aiming to solve the technical problem in the prior art that the process of inputting the user information to the corresponding user pool is time-consuming and manpower-consuming, and results in poor experience.

To achieve the above object, this disclosure provides a method for uploading user information, the method including the following operations: in response to detection of a user information uploading request, obtaining the user information to be uploaded; storing the user information to be uploaded in an intermediate interface table of an uploading system; and selecting the user information to be uploaded from the intermediate interface table at intervals of a predetermined time period, and then uploading the user information to be uploaded that is selected to a target user information pool in batches.

In some embodiments, the block of selecting the user information to be uploaded from the intermediate interface table at intervals of the predetermined time period and uploading the selected user information to be uploaded to the target user information pool in batches includes the following operations; batching the user information in the intermediate interface table according to the order in which the user information enters the intermediate interface table, where the user information to be uploaded in each batch does not exceed a single-time upload capacity of the uploading system; obtaining each of multiple batches of the user information to be uploaded from the intermediate interface table at each interval of the predetermined time period, and then uploading the multiple batches of user information to be uploaded respectively and sequentially to the target user information pool until all user information to be uploaded has been uploaded.

In some embodiments, the block of storing the user information to be uploaded in the intermediate interface table of the uploading system includes the following operations: authenticating the user information to be uploaded; and then storing the user information to be uploaded that has been successfully authenticated in the intermediate interface table of the uploading system, when the authentication succeeds.

In some embodiments, the method further includes the following operation, subsequent to the block of authenticating the user information to be uploaded: when the authentication fails, recording the user information to be uploaded to an error log table, and generating a first notification message.

In some embodiments, the block of authenticating the user information to be uploaded includes: obtaining a type of a user parameter and a length of the user parameter in the user information to be uploaded, comparing the type of the user parameter against a corresponding pre-stored standard parameter type, and comparing the length of the user parameter against a corresponding pre-stored standard parameter length; and when the type of the user parameter is the same as the corresponding pre-stored standard parameter type, and the length of the user parameter is the same as the corresponding pre-stored standard parameter length, determining the authentication is successful.

In some embodiments, the block of storing the user information to be uploaded that has been successfully authenticated in the intermediate interface table of the uploading system when the authentication succeeds includes: when the authentication succeeds, obtaining a user identification number of a user in the user information to be uploaded; determining whether the corresponding user information to be uploaded belongs to repeatedly uploaded user information based on the user identification number; and when the user information to be uploaded does not belong to repeatedly uploaded user information, storing the user information to be uploaded in the intermediate interface table of the uploading system.

In some embodiments, the method further includes the following operation subsequent to the block of determining whether the corresponding user information to be uploaded belongs to repeatedly uploaded user information based on the user identification number: when the user information to be uploaded belongs to repeatedly uploaded user information, then deleting the user information to be uploaded that is repeatedly uploaded, and generating a second notification message.

In some embodiments, the block of obtaining the user information to be uploaded in response to detection of the user information uploading request: in response to detection of the user information uploading request, obtaining the user information to be uploaded through an open application program interface.

In addition, in order to achieve the above object, the present disclosure further provides a device for uploading user information, the device including a memory, a processor, a communication bus, and a user information uploading program stored in the memory. The communication bus is configured to implement a communication connection between the processor and the memory. The processor is configured to execute the user information uploading program to perform the following operations: in response to detection of a user information uploading request, obtaining the user information to be uploaded; storing the user information to be uploaded in an intermediate interface table of an uploading system; and selecting the user information to be uploaded from the intermediate interface table at intervals of a predetermined time period, and then uploading the user information to be uploaded to a target user information pool in batches.

In some embodiments, the block of selecting the user information to be uploaded from the intermediate interface table at intervals of the predetermined time period and uploading the selected user information to be uploaded to the target user information pool in batches includes the following operations: batching the user information in the intermediate interface table according to the order in which the user information enters the intermediate interface table, where the user information to be uploaded in each batch does not exceed a single-time upload capacity of the uploading system; obtaining each of multiple batches of the user information to be uploaded from the intermediate interface table at each interval of the predetermined time period, and then uploading the multiple batches of user information to be uploaded respectively and sequentially to the target user information pool until all user information to be uploaded has been uploaded.

In some embodiments, the block of storing the user information to be uploaded in the intermediate interface table of the uploading system includes the following operations; authenticating the user information to be uploaded, and then storing the user information to be uploaded that has been successfully authenticated in the intermediate interface table of the uploading system, when the authentication succeeds.

In some embodiments, the method further includes the following operation, subsequent to the block of authenticating the user information to be uploaded: when the authentication fails, recording the user information to be uploaded to an error log table, and generating a first notification message.

In some embodiments, the block of authenticating the user information to be uploaded includes: obtaining a type of a user parameter and a length of the user parameter in the user information to be uploaded, comparing the type of the user parameter against a corresponding pre-stored standard parameter type, and comparing the length of the user parameter against a corresponding pre-stored standard parameter length; and when the type of the user parameter is the same as the corresponding pre-stored standard parameter type, and the length of the user parameter is the same as the corresponding pre-stored standard parameter length, determining the authentication is successful.

In some embodiments, the block of storing the user information to be uploaded that has been successfully authenticated in the intermediate interface table of the uploading system when the authentication succeeds includes: when the authentication succeeds, obtaining a user identification number of a user in the user information to be uploaded; determining whether the corresponding user information to be uploaded belongs to repeatedly uploaded user information based on the user identification number; and when the user information to be uploaded does not belong to repeatedly uploaded user information, storing the user information to be uploaded in the intermediate interface table of the uploading system.

In some embodiments, the processor is configured to execute the user information uploading program to further perform the following operation subsequent to the block of determining whether the corresponding user information to be uploaded belongs to repeatedly uploaded user information based on the user identification number: when the user information to be uploaded belongs to repeatedly uploaded user information, then deleting the user information to be uploaded that is repeatedly uploaded, and generating a second notification message.

In some embodiments, the block of obtaining the user information to be uploaded in response to detection of the user information uploading request: in response to detection of the user information uploading request, obtaining the user information to be uploaded through an open application program interface.

Further, in order to achieve the foregoing object, the present disclosure further provides a computer-readable storage medium that stores one or more programs, which can be executed by one or more processors to perform the following operations: in response to detection of a user information uploading request, obtaining the user information to be uploaded; storing the user information to be uploaded in an intermediate interface table of an uploading system; and selecting the user information to be uploaded from the intermediate interface table at intervals of a predetermined time period, and then uploading the user information to be uploaded to a target user information pool in batches.

According to this disclosure, when a user information uploading request is detected, the user information to be uploaded is obtained. The user information to be uploaded is then stored in an intermediate interface table of the uploading system. Then the user information to be uploaded is selected from the intermediate interface table at intervals of a predetermined time period and then uploaded to the target user information pool in batches. Because the uploading system according to this disclosure is configured with an intermediate interface table which stores or buffers the acquired various types of user information, when the capacity of the user information is too large and the user information items are exceedingly numerous, the uploading system can first buffer or store the user information before uploading the user information to the corresponding user pool in batches, thanks to the existence of the intermediate interface table. This therefore solves the technical problem in the prior art that the process of importing the user information to the corresponding user pool can be time-consuming and laborious resulting in poor experience.

### BRIEF DESCRIPTION OF THE ACCOMPANYING DRAWINGS

FIG. 1 is an illustrative flowchart of a first embodiment of a method for uploading user information in accordance with this disclosure.

FIG. 2 is an illustrative flowchart of a second embodiment of a method for uploading user information in accordance with this disclosure.

FIG. 3 is a schematic diagram of a device in terms of hard operating environment involved in the method embodiments in accordance with this disclosure.

FIG. 4 is a schematic diagram of a scenario in accordance with an embodiment of this disclosure.

Various implementations, functional features, and advantages of this disclosure will now be described in further detail in connection with some illustrative embodiments and the accompanying drawings.

### DETAILED DESCRIPTION OF ILLUSTRATIVE EMBODIMENTS

It will be appreciated that the specific embodiments described herein are merely illustrative of the disclosure and are not intended to limit the disclosure.

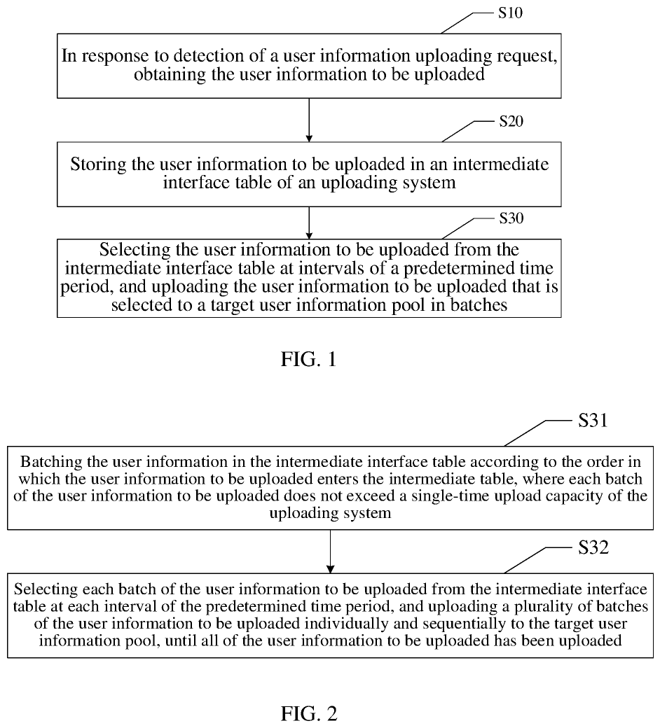

This disclosure provides a method for uploading user information. As illustrated in FIG. 1, in a first embodiment of the method for uploading user information in accordance with the present disclosure, the method includes the following blocks S10 to S30.

In S10, in response to detection of a user information uploading request, the user information to be uploaded is obtained.

The method for uploading user information of this application is applied to an uploading system. As illustrated in FIG. 4, a client that needs to process user information uploads the user information to a corresponding target user information pool through the uploading system in this application, where the target user information pool is configured for orderly integration and storage of the user information. The uploading system in the present application includes a data uploading system and the like. When detecting a user information uploading request, the uploading system obtains the user information to be uploaded. In particular, a monitoring module is pre-configured in the uploading system, and it monitors in real time whether the uploading system receives a user information uploading request from the client. If the monitoring module detects the user information uploading request from the client, then the uploading system responds to the user information uploading request so as to obtain the user information to be uploaded. Specifically, the uploading of the user information on the client may be triggered by means of a click or a touch on a preset area. Further, in the uploading system of this application, a program segment is configured in the built-in processor in advance, where the program segment represents the processing logic for responding to the client's request of uploading user information. In particular, the processing logic is configured to acquire the user information to be uploaded upon detection of the user information uploading request. Therefore, the user information to be uploaded can be accurately obtained.

The user information may include various different parameters. For example, the user information may include parameters such as the user's mobile phone number, account number, credential type, and birthplace address. The user information can be uploaded as a table, a document, or in other forms. Prior to uploading the user information, the client has already organized the user information according to a preset format so that it meets the format requirements for uploading. During the uploading process, the uploading system may acquire the user information to be uploaded through an open application program interface. In a specific embodiment, for example, a client I needs to save the user information in an application W to a target user information pool, then the uploading system can directly invoke the user information in the application W through the open application program interface of the application W, without needing to first downloading the user information in the application W before uploading. Alternatively or additionally, the uploading system can obtain the user information by means of an attachment. The method then continues to block S20.

In S20, the user information to be uploaded is stored in an intermediate interface table of the uploading system.

In this application, there may be one or more clients. The uploading system is configured with an intermediate interface table for buffering or receiving the user information uploaded by a client. There may be configured one or more intermediate interface tables. In the case where there are multiple intermediate interface tables, they can be classified, e.g. depending on a display format of the user information. The display format of the user information can include an Excel table display format, a Word display format, etc. Therefore, the corresponding intermediate interface table may be an intermediate user information interface Excel table, or an intermediate user information interface Word table. In a specific embodiment, for example, when the display format of the user information is the Excel table display format, then the user information to be uploaded would be stored in the intermediate user information interface Excel table. Alternatively or additionally, when the display format of the user information is the Word display format, then the user information to be uploaded would be stored in the intermediate user information interface Word table. During the process of importing and storing the user information to be uploaded to the intermediate interface table of the uploading system, the user information to be uploaded that enters the intermediate interface table is prioritized or numbered according to the chronological order in which the user information is imported. In the case where there are multiple intermediate interface tables, each intermediate interface table would individually prioritize or number the user information to be uploaded that is imported. The method then proceeds to block S30.

In S30, the user information to be uploaded is selected from the intermediate interface table at intervals of a predetermined time period, and then uploaded to a target user information pool in batches.

As illustrated in FIG. 2, the block of selecting the user information to be uploaded from the intermediate interface table at intervals of the predetermined time period and uploading the selected user information to be uploaded to the target user information pool in batches includes the following operations S31 and S32.

In S31, the user information in the intermediate interface table is batched according to the order in which the user information enters the intermediate interface table, where the user information to be uploaded in each batch does not exceed a single-time upload capacity of the uploading system.

In S32, each of multiple batches of user information to be uploaded is retrieved from the intermediate interface table at each interval of the predetermined time period, and then the multiple batches of user information to be uploaded are respectively and sequentially uploaded to the target user information pool until all user information to be uploaded has been uploaded.

At intervals of the predetermined time period, the uploading system acquires the user information to be uploaded from the intermediate interface table, and further uploads the user information to be uploaded in sequence to the target user information pool. If there are multiple intermediate interface tables, then the uploading system first selects a target intermediate interface table, and afterwards selects the user information to be uploaded from the target intermediate interface table before uploading the user information to be uploaded that is selected to the target user information pool. For different intermediate interface tables, the time points at which the uploading system performs the process of obtaining the various batches of user information to be uploaded from the intermediate interface table and then respectively and sequentially uploading the various batches of user information to be uploaded to the target user information pool can be different from each other. For example, the uploading system may perform the operation of retrieving the user information to be uploaded from an intermediate interface table A at 1 AM every day, while performing the operation of retrieving the user information to be uploaded from an intermediate interface table B at 3 PM every day, so as to fulfill the purpose of preventing the uploading system from collapse. In addition, before selecting the user information to be uploaded from the intermediate interface table at intervals of the predetermined time period (where the predetermined time period is generally 1 day), the uploading system has already batched the user information according to the chronological order in which the user information to be uploaded enters the intermediate interface table, where each batch of user information to be uploaded does not exceed the single-time upload capacity of the uploading system. The single-time upload capacity of the uploading system is pre-stored in the uploading system and is known. At each interval of the predetermined time period, each of multiple batches of the user information to be uploaded is obtained from the intermediate interface table, and multiple batches of user information to be uploaded are then respectively and sequentially uploaded to the target user information pool, until all the user information to be uploaded is uploaded.

In a specific embodiment, for example, the uploading system may perform the operation of retrieving the user information to be uploaded from the intermediate interface table A at 1 AM every day, where the uploading system uploads user information of a maximum size of 10 M in a single upload. If the size of the user information to be uploaded in the intermediate interface table A is 100 M, then the uploading system may batch the user information to be uploaded with a size of 100 M, so that the user information to be uploaded with a size of 100 M is divided into 10 batches. As such, the uploading system can accomplish the uploading of the user information to be uploaded with a size of 100 M in batches.

According to this disclosure, when a user information uploading request is detected, the user information to be uploaded is obtained. The user information to be uploaded is then stored in an intermediate interface table of the uploading system. Then the user information to be uploaded is selected from the intermediate interface table at intervals of the predetermined time period and then uploaded to the target user information pool in batches. Because the uploading system according to this disclosure is configured with an intermediate interface table which stores or buffers the acquired various types of user information, when the capacity of the user information is too large and the user information items are exceedingly numerous, the uploading system can first buffer or store the user information before uploading the user information to the corresponding user pool in batches, thanks to the existence of the intermediate interface table. This therefore solves the technical problem in the prior art that the process of importing the user information to the corresponding user pool can be time-consuming and laborious resulting in poor experience.

Further, a second embodiment of the method for uploading user information is provided herein on the basis of the first embodiment of the method for uploading user information according to this disclosure. In the second embodiment, the block of storing the user information to be uploaded in the intermediate interface table of the uploading system includes the following operations.

The user information to be uploaded is first authenticated. When the authentication succeeds, then the user information to be uploaded that has been successfully authenticated would be stored in the intermediate interface table of the uploading system.

The block of authenticating the user information to be uploaded and storing the user information to be uploaded that is successfully authenticated in the intermediate interface table of the uploading system when the authentication succeeds includes the following operations: obtaining a type of a user parameter and a length of the user parameter in the user information to be uploaded, comparing the type of the user parameter against a corresponding pre-stored standard parameter type, and comparing the length of the user parameter against a corresponding pre-stored standard parameter length; and when the type of the user parameter is the same as the corresponding pre-stored standard parameter type, and the length of the user parameter is the same as the corresponding pre-stored standard parameter length, determining the authentication is successful; and when the authentication succeeds, storing the user information to be uploaded in an intermediate interface table of an uploading system.

Before uploading the user information, the user information to be uploaded needs to be authenticated, where the user information includes user parameters and various types of standard information for authentication has been stored in the uploading system. During the authentication process, the type of a user parameter in the user information to be uploaded is first acquired and compared against a corresponding pre-stored standard parameter type. Further, the length of the user parameter is compared against a corresponding pre-stored standard parameter length. In a specific embodiment, for example, if the user parameter in the user information to be uploaded is the user's phone number, then the type of the user's phone number is first compared against the type of the pre-stored phone number to determine whether the type of the user's phone number is of the same as the type of the pre-stored phone number. For example, both may be in the form of landlines or mobile phones. When the types are the same, the length of the user's phone number would be determined. For example, if this phone number has a length of 11, namely the same as the pre-stored length, then the authentication succeeds. When the authentication is successful, then the user information to be uploaded would be stored in the intermediate interface table of the uploading system.

In this embodiment, the user information to be uploaded is authenticated. When the authentication succeeds, the operation of storing the user information to be uploaded in the intermediate interface table of the uploading system is performed. Thus, the accuracy of the user information to be uploaded stored in the intermediate interface table of the uploading system is improved, and the user experience is improved.

Further, a third embodiment of the method for uploading user information is provided herein on the basis of the second embodiment of the method for uploading user information according to this disclosure. In the third embodiment, the method further includes the following operation subsequent to the block of authenticating the user information to be uploaded: when the authentication fails, recording the user information to be uploaded to an error log table, and generating a first notification message.

When the authentication fails, the user information to be uploaded that fails to be authenticated is recorded to the error log table. The error log table may further include time information of this failed authentication as well as the authentication record during the authentication failure process. When the authentication fails, a first notification message may also be generated. The notification message may be in an audio format or optical format and is used to remind the client that the corresponding user information to be uploaded fails on the authentication.

In this embodiment, when the authentication fails, the user information to be uploaded that fails the authentication is recorded in the error log table, and the first notification message is generated. Therefore, the user can be promptly reminded to further process the user information that fails the authentication, thereby improving the user experience.

Further, a fourth embodiment of the method for uploading user information is provided herein on the basis of the second embodiment of the method for uploading user information according to this disclosure. In the fourth embodiment, the block of storing the user information to be uploaded in the intermediate interface table of the uploading system includes the following operations: when the authentication succeeds, obtaining a user identification number of a user in the user information to be uploaded; determining whether the corresponding user information to be uploaded belongs to repeatedly uploaded user information based on the user identification number; and when the user information to be uploaded does not belong to repeatedly uploaded user information, storing the user information to be uploaded in the intermediate interface table of the uploading system.

The method may further include the following operation subsequent to determining whether the corresponding user information to be uploaded belongs to repeatedly uploaded user information based on the user identification number: when the user information to be uploaded belongs to repeatedly uploaded user information, then deleting the user information to be uploaded that is repeatedly uploaded, and generating a second notification message.

When the authentication succeeds, the user identification number of the user information to be uploaded needs to further be obtained. This user identification number is then used to traverse the user identification numbers of various users in the target user information pool for a match, for the purpose of determining whether the corresponding user belongs to repeatedly uploaded user information. When the user information to be uploaded does not belong to repeatedly uploaded user information, then the user information to be uploaded would be stored in the intermediate interface table of the uploading system so as to upload the user information to be uploaded within a preset period of time. Otherwise when the user information to be uploaded belongs to repeatedly uploaded user information, then the user information to be uploaded that is repeatedly uploaded is deleted while a second notification message is generated. The second notification message is in an audio format or optical format distinguished from the first notification message. When the user information to be uploaded belongs to repeatedly uploaded user information, a repetitive upload record report may also be generated to record the repeatedly uploaded user information.

In this embodiment, when the authentication succeeds, the user identification number of the user in the user information to be uploaded is obtained. Then based on the user identification number, it is determined whether the corresponding user information to be uploaded belongs to repeatedly uploaded user information. When the user information to be uploaded does not belong to repeatedly uploaded user information, the user information to be uploaded would be stored in the intermediate interface table of the uploading system. In this application, repeated uploading of user data is avoided, so the client experience is improved.

Further, a fifth embodiment of the method for uploading user information is provided herein on the basis of the fourth embodiment of the method for uploading user information according to this disclosure. In the fifth embodiment, the block of obtaining the user information to be uploaded in response to detection of the user information uploading request includes the following operation: in response to detection of the user information uploading request, obtaining the user information to be uploaded through an open application program interface.

In this embodiment, the uploading system may not only upload the user information by means of attachment, but may also acquire the user information to be uploaded through the open application program interface, where there may be one or more open application program interfaces. During the process of acquiring the user information to be uploaded through the open application program interface, the uploading system may buffer the user information to be uploaded on the local end of the uploading system, and then uploads the user information to be uploaded that is buffered on the local end to the target user pool in batches.

In this embodiment, when the user information uploading request is detected, the user information to be uploaded is obtained through the open application program interface. Thus, this embodiment adds to the ways of acquiring the user information, improving the user experience.

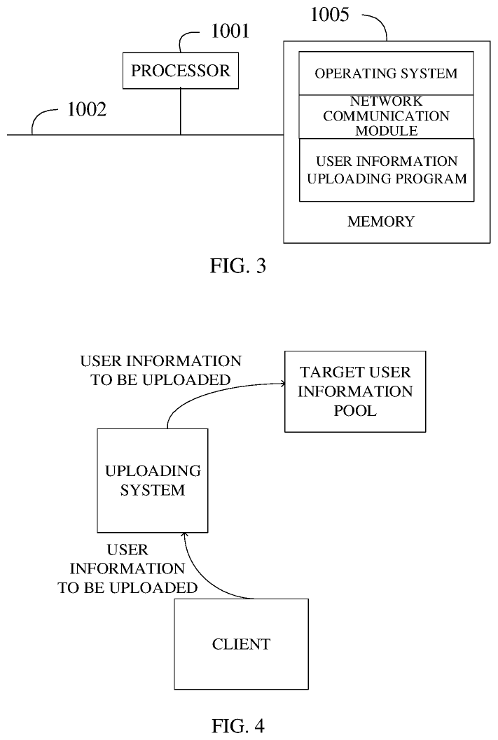

FIG. 3 is a schematic diagram of a device in terms of hard operating environment involved in the method embodiments in accordance with this disclosure.

The device for uploading user information according to this embodiment of the present disclosure may be a personal computer (PC), or a terminal device such as a smart phone, a tablet computer, an e-book reader, an MP3 (Moving Picture Experts Group Audio Layer III) player, a MP4 (Moving Picture Experts Group Audio Layer IV) player, a portable computer, and so on.

As illustrated in FIG. 3, the device for uploading user information may include a processor 1001 such as a CPU, a memory 1005, and a communication bus 1002. The communication bus 1002 is configured to implement connection and communication between the processor 1001 and the memory 1005. The memory 1005 may be a high-speed RAM memory, or a non-volatile memory such as a disk memory. The memory 1005 optionally may also be a storage device that is separate from the processor 1001 described above.

Optionally, the device for uploading information may further include a user interface, a network interface, a camera, an RF (Radio Frequency) circuitry, a sensor, an audio circuitry, a WiFi module, and the like. The user interface may include a display, an input unit such as a keyboard, and an optional user interface may also include a standard wired interface and wireless interface. The network interface may optionally include a standard wired interface, and a wireless interface (such as a WI-FI interface).

Those skilled in the art can understand that the structure of the user information uploading device illustrated in FIG. 3 does not constitute a limitation on the user information uploading device. Thus, the user information uploading device may include more or less components than those illustrated, or some components may be combined, or different arrangements of components may be employed.

As illustrated in FIG. 3, the memory 1005 as a computer storage medium may include an operating system, a network communication module, and a user information uploading program. The operating system is a program that manages and controls the hardware and software resources of the device for uploading user information, and supports the operation of the user information uploading program and other software and/or programs. The network communication module is configured to implement the communication between various components within the memory 1005, and with other hardware and software in the device for uploading user information.

In the device for uploading user information as illustrated in FIG. 3, the processor 1001 is configured to execute the user information uploading program stored in the memory 1005 to perform the following operations: in response to detection of a user information uploading request, obtaining the user information to be uploaded; storing the user information to be uploaded in an intermediate interface table of an uploading system; and selecting the user information to be uploaded from the intermediate interface table at intervals of a predetermined time period, and then uploading the user information to be uploaded to a target user information pool in batches.

Further, the block of selecting the user information to be uploaded from the intermediate interface table at intervals of the predetermined time period and uploading the selected user information to be uploaded to the target user information pool in batches includes the following operations: batching the user information in the intermediate interface table according to the order in which the user information enters the intermediate interface table, where the user information to be uploaded in each batch does not exceed a single-time upload capacity of the uploading system; and obtaining each of multiple batches of user information to be uploaded from the intermediate interface table at each interval of the predetermined time period, and then uploading the multiple batches of user information to be uploaded respectively and sequentially to the target user information pool until all user information to be uploaded has been uploaded.

Further, the block of storing the user information to be uploaded in the intermediate interface table of the uploading system includes the following operations.

The user information to be uploaded is first authenticated. When the authentication succeeds, then the user information to be uploaded that has been successfully authenticated would be stored in the intermediate interface table of the uploading system.

Further, the processor 1001 is configured to execute the user information uploading program stored in the memory 1005 to further perform the following operation, subsequent to authenticating the user information to be uploaded: when the authentication fails, recording the user information to be uploaded to an error log table, and generating a first notification message.

Further, the block of authenticating the user information to be uploaded includes the following operations: obtaining a type of a user parameter and a length of the user parameter in the user information to be uploaded, comparing the type of the user parameter against a corresponding pre-stored standard parameter type, and comparing the length of the user parameter against a corresponding pre-stored standard parameter length; and when the type of the user parameter is the same as the corresponding pre-stored standard parameter type, and the length of the user parameter is the same as the corresponding pre-stored standard parameter length, determining the authentication is successful; and

Further, the block of storing the user information to be uploaded that has been successfully authenticated in the intermediate interface table of the uploading system when the authentication succeeds includes: when the authentication succeeds, obtaining a user identification number of a user in the user information to be uploaded; determining whether the corresponding user information to be uploaded belongs to repeatedly uploaded user information based on the user identification number; and when the user information to be uploaded does not belong to repeatedly uploaded user information, storing the user information to be uploaded in the intermediate interface table of the uploading system.

Further, the processor 1001 is configured to execute the user information uploading program stored in the memory 1005 to further perform the following operation, subsequent to determining whether the corresponding user information to be uploaded belongs to repeatedly uploaded user information based on the user identification number: when the user information to be uploaded belongs to repeatedly uploaded user information, then deleting the user information to be uploaded that is repeatedly uploaded, and generating a second notification message.

Further, the block of obtaining the user information to be uploaded in response to detection of the user information uploading request includes the following operation: in response to detection of the user information uploading request, obtaining the user information to be uploaded through an open application program interface.

The specific implementations of the device for uploading user information according to this disclosure are substantially the same as the various embodiments of the method for uploading user information described above. Thus, they are not to be detailed herein again.

The present disclosure provides a computer-readable storage medium storing one or more programs which can be executed by one or more processors to perform the steps of the above-described method for uploading user information.

The specific implementations of the computer-readable storage medium according to this disclosure are substantially the same as the various embodiments of the method for uploading user information described above. Thus, they are not to be detailed herein again.

The foregoing description merely portrays some illustrative embodiments according to the disclosure and therefore is not intended to limit the patentable scope of the disclosure. Any equivalent structural or flow transformations that are made taking advantage of the specification and accompanying drawings of the disclosure and any direct or indirect applications thereof in other related technical fields shall all fall in the scope of protection of the disclosure.

1. A method for uploading user information, comprising:
in response to detection of a user information uploading request, obtaining the user information to be uploaded;
storing the user information to be uploaded in an intermediate interface table of an uploading system; and
selecting the user information to be uploaded from the intermediate interface table at intervals of a predetermined time period, and uploading the user information to be uploaded that is selected to a target user information pool in batches.

2. The method of claim 1, wherein the block of selecting the user information to be uploaded from the intermediate interface table at intervals of the predetermined time period and uploading the selected user information to be uploaded that is selected to the target user information pool in batches comprises:
batching the user information in the intermediate interface table according to the order the user information entering the intermediate interface table, wherein each batch of the user information to be uploaded does not exceed a single-time upload capacity of the uploading system; and
obtaining each of a plurality of batches of the user information to be uploaded from the intermediate interface table at each interval of the predetermined time period, and uploading the plurality of batches of the user information to be uploaded respectively and sequentially to the target user information pool until all of the user information to be uploaded has been uploaded.

3. The method of claim 1, wherein the block of storing the user information to be uploaded in the intermediate interface table of the uploading system comprises:
authenticating the user information to be uploaded, and storing the user information to be uploaded that has been successfully authenticated in the intermediate interface table of the uploading system, when the authentication succeeds.

4. The method of claim 3, subsequent to authenticating the user information to be uploaded, further comprising:
when the authentication fails, recording the user information to be uploaded to an error log table, and generating a first notification message.

5. The method of claim 3, wherein the block of authenticating the user information to be uploaded and storing the user information to be uploaded that has been successfully authenticated in the intermediate interface table of the uploading system when the authentication succeeds comprises:
obtaining a type of a user parameter and a length of the user parameter in the user information to be uploaded, comparing the type of the user parameter against a corresponding pre-stored standard parameter type, and comparing the length of the user parameter against a corresponding pre-stored standard parameter length; and
when the type of the user parameter is the same as the corresponding pre-stored standard parameter type, and the length of the user parameter is the same as the corresponding pre-stored standard parameter length, determining the authentication being successful; and
when the authentication succeeds, storing the user information to be uploaded that has been successfully authenticated in the intermediate interface table of the uploading system.

6. The method of claim 3, wherein the block of storing the user information to be uploaded that has been successfully authenticated in the intermediate interface table of the uploading system when the authentication succeeds comprises:
when the authentication succeeds, obtaining a user identification number of a user in the user information to be uploaded;
determining whether the corresponding user information to be uploaded belongs to repeatedly uploaded user information based on the user identification number; and
when the user information to be uploaded does not belong to repeatedly uploaded user information, storing the user information to be uploaded in the intermediate interface table of the uploading system.

7. The method of claim 6, subsequent to determining whether the corresponding user information to be uploaded belongs to repeatedly uploaded user information based on the user identification number, further comprising:
when the user information to be uploaded belongs to repeatedly uploaded user information, deleting the user information to be uploaded that is repeatedly uploaded, and generating a second notification message.

8. The method of claim 1, wherein the block of obtaining the user information to be uploaded in response to detection of the user information uploading request comprises:
in response to detection of the user information uploading request, obtaining the user information to be uploaded through an open application program interface.

9. The method of claim 2, wherein the block of obtaining the user information to be uploaded in response to detection of the user information uploading request comprises:
in response to detection of the user information uploading request, obtaining the user information to be uploaded through an open application program interface.

10. The method of claim 3, wherein the block of obtaining the user information to be uploaded in response to detection of the user information uploading request comprises:
in response to detection of the user information uploading request, obtaining the user information to be uploaded through an open application program interface.

11. The method of claim 4, wherein the block of obtaining the user information to be uploaded in response to detection of the user information uploading request comprises:
in response to detection of the user information uploading request, obtaining the user information to be uploaded through an open application program interface.

12. The method of claim 5, wherein the block of obtaining the user information to be uploaded in response to detection of the user information uploading request comprises:
in response to detection of the user information uploading request, obtaining the user information to be uploaded through an open application program interface.

13. The method of claim 6, wherein the block of obtaining the user information to be uploaded in response to detection of the user information uploading request comprises:
in response to detection of the user information uploading request, obtaining the user information to be uploaded through an open application program interface.

14. The method of claim 7, wherein the block of obtaining the user information to be uploaded in response to detection of the user information uploading request comprises:
in response to detection of the user information uploading request, obtaining the user information to be uploaded through an open application program interface.

15. A device for uploading user information, the device comprising a memory, a processor, a communication bus, and a user information uploading program stored in the memory,
the communication bus being configured to implement a communication connection between the processor and the memory;
the processor being configured to execute the user information uploading program to perform the following operations:
in response to detection of a user information uploading request, obtaining the user information to be uploaded;
storing the user information to be uploaded in an intermediate interface table of an uploading system; and
selecting the user information to be uploaded from the intermediate interface table at intervals of a predetermined time period, and uploading the user information to be uploaded that is selected to a target user information pool in batches.

16. The device of claim 15, wherein the block of storing the user information to be uploaded in the intermediate interface table of the uploading system comprises:
authenticating the user information to be uploaded, and storing the user information to be uploaded that has been successfully authenticated in the intermediate interface table of the uploading system, when the authentication succeeds.

17. A computer-readable storage medium storing a user information uploading program, which when executed by a processor performs the following operations:
in response to detection of a user information uploading request, obtaining the user information to be uploaded;
storing the user information to be uploaded in an intermediate interface table of an uploading system; and
selecting the user information to be uploaded from the intermediate interface table at intervals of a predetermined time period, and uploading the user information to be uploaded that is selected to a target user information pool in batches.

18. The computer-readable storage medium of claim 17, wherein the block of selecting the user information to be uploaded from the intermediate interface table at intervals of the predetermined time period and uploading the selected user information to be uploaded that is selected to the target user information pool in batches comprises:
batching the user information in the intermediate interface table according to the order in which the user information enters the intermediate interface table, wherein each batch of the user information to be uploaded does not exceed a single-time upload capacity of the uploading system; and
obtaining each of a plurality of batches of the user information to be uploaded from the intermediate interface table at each interval of the predetermined time period, and uploading the plurality of batches of the user information to be uploaded respectively and sequentially to the target user information pool until all of the user information to be uploaded has been uploaded.

19. The computer-readable storage medium of claim 18, wherein the block of storing the user information to be uploaded in the intermediate interface table of the uploading system comprises:
authenticating the user information to be uploaded, and storing the user information to be uploaded that has been successfully authenticated in the intermediate interface table of the uploading system, when the authentication succeeds.

20. The device of claim 15, wherein the block of selecting the user information to be uploaded from the intermediate interface table at intervals of the predetermined time period and uploading the selected user information to be uploaded that is selected to the target user information pool in batches comprises:
batching the user information in the intermediate interface table according to the order the user information entering the intermediate interface table, wherein each batch of the user information to be uploaded does not exceed a single-time upload capacity of the uploading system; and
obtaining each of a plurality of batches of the user information to be uploaded from the intermediate interface table at each interval of the predetermined time period, and uploading the plurality of batches of the user information to be uploaded respectively and sequentially to the target user information pool until all of the user information to be uploaded has been uploaded.
